(19) United States
(12) Patent Application Publication
(10) Pub. No.: US 2021/0084417 A1
(43) Pub. Date: Mar. 18, 2021

(54) WIRELESS CONNECTION ONBOARDING FOR A HEARING DEVICE

(71) Applicant: Sonova AG, Staefa (CH)

(72) Inventors: Vladimir Bagazov, Zurich (CH); Philipp Schneider, Zurich (CH)

(21) Appl. No.: 16/572,639

(22) Filed: Sep. 17, 2019

(51) Int. Cl. H04R 25/00; H04B 5/00; H04W 4/80

(52) U.S. Cl. CPC H04R 25/554; H04B 5/0006; H04B 5/0031; H04R 25/65; H04W 12/003; H04W 4/80; H04R 2225/0216; H04R 2225/023; H04B 5/0037

(57) ABSTRACT

The disclosed technology wirelessly connects a pair of hearing devices to a computing device using an NFC tag. In some implementations, the NFC tag is associated with a credit card or identification card for the user. In other implementations, the NFC tag is associated with hearing device box that is configured to hold the hearing devices and/or charge the hearing devices while in the box. The NFC tag can be associated with the user and the hearing devices associated with the user. To use the NFC tag to wirelessly connect the hearing device to a computing device, the user can simply tap the wireless communication device against the card of the hearing device box. The NFC tag can also be linked to an ID associated a hearing device user, a hearing device, and a hearing care professional to establish a fitting session (e.g., a distance fitting session over the internet).

### TECHNICAL FIELD

The disclosed technology generally relates to wirelessly connecting hearing devices to a wireless communication device (e.g., a mobile phone). Specifically, the disclosed technology wirelessly connects a pair of hearing devices to a mobile phone using a near-field communication (NFC) tag.

### BACKGROUND

Hearing aids are generally small devices that provide hearing assistance to users wearing the devices. In recent years, hearing aid manufacturers have added wireless communication capability to hearing aids, e.g., Bluetooth™ capability. Additionally, hearing aid manufacturers have reduced the size of hearing aids to draw less attention to the users wearing the devices.

Although wireless communication capability and reduced size have improved the hearing device user experience, hearing aid users still struggle with some aspects of this new technology. For example, to wirelessly connect a hearing aid to another hearing aid or to a mobile phone, a user generally performs a pairing operation. The pairing operation can require turning on or off the hearing aid, removing the hearing aids from the user's ears, or opening and closing the battery door for the hearing aid to activate a pairing mode for the hearing device. This pairing operation can be burdensome for a hearing aid user as it requires several steps and dexterity, which may be lacking in many older hearing aid users faced with manipulating hearing aids or hearing aid components that are small.

Accordingly, there exists a need for a hearing aid, system, or method that improves a user's experience when wirelessly connecting a hearing aid to another device and it should also provide additional benefits.

### BRIEF DESCRIPTION OF THE FIGURES

FIG. 1 is a schematic illustration of a hearing device user wearing hearing devices in accordance with some implementations of the disclosed technology.

FIG. 2A is a schematic illustration of the hearing devices from FIG. 1 wirelessly connecting with the wireless communication device from FIG. 1 device in accordance with some implementations of the disclosed technology.

FIG. 2B is a schematic illustration of a hearing device and a card with a NFC tag in accordance with some implementations of the disclosed technology.

FIG. 2C is a schematic illustration of a wireless communication device and a hearing device holder with a NFC tag in accordance with some implementations of the disclosed technology.

FIG. 3 is a schematic illustration of hearing devices, a wireless communication device, and a card with an NFC tag used to start a fitting session in accordance with some implementations of the disclosed technology.

FIG. 4 is a block diagram of a process for wirelessly connecting a hearing device with a wireless communication device in accordance with the disclosed technology.

The drawings are not to scale. Some components or operations may be separated into different blocks or combined into a single block for the purposes of discussion of some of the disclosed technology. Moreover, while the disclosed technology is amenable to various modifications and alternative forms, specific implementations have been shown by way of example in the drawings and are described in detail below. The intention, however, is not to limit the disclosed technology to the selected implementations described. Rather, this disclosure covers all modifications, equivalents, and alternatives falling within the scope of the disclosed technology as defined by the appended claims.

### DETAILED DESCRIPTION

To improve a user's experience with pairing, the disclosed technology includes automatically pairing and wirelessly connecting a hearing device (or hearing devices) with a wireless communication device based on a NFC tag. The NFC tag can be physically coupled to a card, which the user can carry. Alternatively, the NFC tag can be physically coupled to a hearing device holder that is configured to store and wirelessly charge the hearing devices. Specifically, the hearing device holder can be plugged into a wall and then hearing devices placed in the hearing device holder unit, wherein the charger unit can charge the hearing devices through inductive charging.

The disclosed technology can use the NFC tag to lookup information about the hearing device user and information related to pairing the hearing devices to the wireless communication device (e.g., pairing information, device information). A hearing device user may find that wirelessly connecting the hearing device to mobile device is convenient and easy as it just requires the user touching or placing their mobile phone close to the NFC tag to read the NFC tag and use it for a read and lookup operation. Also, the NFC tag can be associated with an ID, and the wireless communication device can use the ID to look up hearing care professional information associated with the hearing device and/or hearing device user. Based on the hearing care professional information, the wireless communication can launch a fitting session (e.g., using an email address, HTTP link, or other information to start a video conference between a hearing care professional and the hearing device user).

The disclosed technology includes a method to pair and wirelessly connect the hearing device to a wireless communication device. The method can include: receiving an indication that a hearing device user wishes to wirelessly connect a hearing device to a wireless communication device. For example, a mobile phone user can open a mobile application and indicate that he or she wants to wirelessly connect his or her hearing devices by pressing a button on a graphical user interface of the mobile phone. The method can also include detecting an NFC tag that is associated with the hearing device, the hearing device user, or information for wirelessly connecting the hearing device. The wireless communication device can then use this NFC tag and information it can read from the NFC tag to perform a lookup operation to determine wireless connection information (e.g., pairing information to pair the device; association with a hearing care professional and how to connect with that hearing care professional). Also, the wireless communication device can retrieve an identification number (ID) and use it to retrieve specific information for pairing or setting up a fitting session. After determining wireless connection information based on a detected NFC tag and database look up, the wireless communication device and the hearing device can automatically connect without further input from the user.

Also, the disclosed technology can include starting a virtual fitting session between the hearing device user and a hearing care professional (HCP) based on reading the NFC tag. A virtual fitting session is a virtual meeting between a hearing device user and an HCP where the HCP can communicate with the user regarding the hearing device or devices and adjust the hearing device via software (e.g., fitting software). In some implementations, based on detecting NFC tag, a user's mobile phone can start a video chat between the hearing device user and the HCP (e.g., based on a link, email address, or contact information for the HCP). During the video chart, the HCP can have access to the user's information and hearing devices. The HCP can adjust the hearing device and receive feedback from the hearing device user during the virtual fitting session.

In some implementations, the disclosed technology solves a technical problem with a practical application of a technical solution. Specifically, the disclosed technology includes a system and computer-implemented method to pair and wirelessly connect hearing devices automatically based on an NFC tag, and this assists a user in saving time and avoiding frustration with the pairing and wireless connection process. The disclosed technology can also automatically look up a hearing care professional's contact information associated with a hearing device (e.g., hearing aid ID). Based on the linked hearing care professional contact information, the disclosed technology enables a user to launch a fitting session based on a single sign-on (e.g., a mobile phone reading an NFC tag).

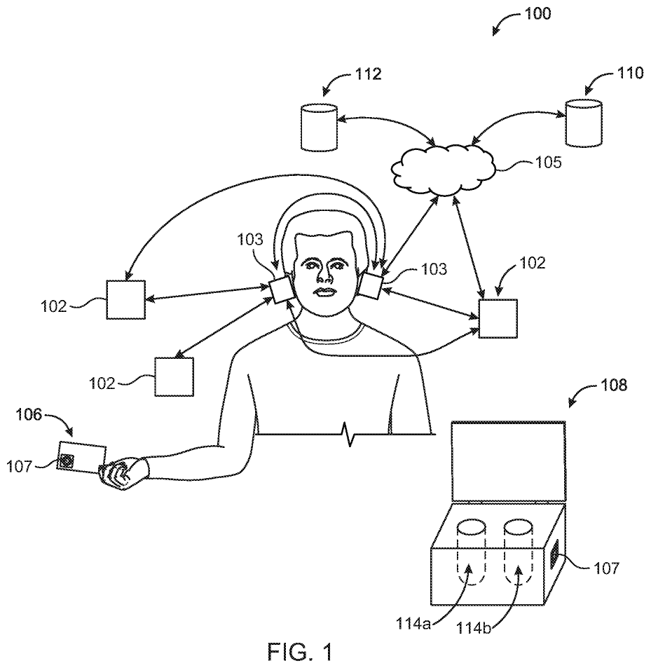

FIG. 1 illustrates a communication environment 100. The communication environment 100 includes wireless communication devices 102 and hearing devices 103 (also referred to as a single wireless communication device 102 and multiple wireless communications devices 102; a signal hearing device 103 and multiple hearing devices 103).

As shown by double-headed bold arrows in FIG. 1, the wireless communication devices 102 and the hearing devices 103 can communicate wirelessly. Wireless communication can include using a protocol such as Bluetooth BR/EDR™, Bluetooth Low Energy™, a proprietary communication (e.g., binaural communication protocol between hearing aids or bimodal communication protocol between a hearing aid and hearing device), ZigBee™, Wi-Fi™, or an Industry of Electrical and Electronic Engineers (IEEE) wireless communication standard protocol.

The hearing devices 103 are configured to provide sound to a hearing device user. Some example hearing devices include hearing aids, headphones, earphones, assistive listening devices, or any combination thereof; and hearing devices include both prescription devices and non-prescription devices configured to be worn on or near a human head.

As an example of a hearing device, a hearing aid is a device that provides amplification, attenuation, or frequency modification of audio signals to compensate for hearing loss or difficulty. Hearing aids include Behind-the-Ear (BTE), Receiver-in-the-Canal (RIC), In-the-Ear (ITE), Completely-in-the-Canal (CIC), Invisible-in-the-Canal (IIC) hearing aids or a cochlear implant (where a cochlear implant includes a device part and an implant part).

Also, the hearing devices 103 can be configured to binaurally communicate or bimodally communicate. The binaural communication can include a hearing device 103 transmitting information to or receiving information from another hearing device 103. Information can include volume control, signal processing information (e.g., noise reduction, wind canceling, directionality such as beam forming information), or compression information to modify sound fidelity or resolution. Binaural communication can be bidirectional (e.g., between hearing devices) or unidirectional (e.g., one hearing device receiving or streaming information from another hearing device). Bimodal communication is like binaural communication, but bimodal communication includes a cochlear device communicating with a hearing aid. For example, the hearing devices 103 can communicate filter information or exchange filters.

Hearing devices 103 can include a processor, a memory (or memories), a battery, a microphone, and a speaker. The processor can include special-purpose hardware such as application specific integrated circuits (ASICs), programmable logic devices (PLDs), field-programmable gate arrays (FPGAs), programmable circuitry (e.g., one or more microprocessors microcontrollers), Digital Signal Processor (DSP), appropriately programmed with software and/or computer code, or a combination of special purpose hardware and programmable circuitry.

The wireless communication devices 102 are computing devices that are configured to wirelessly communicate. Wireless communication includes wirelessly transmitting information, wirelessly receiving information (e.g., streaming audio), or both. The wireless communication devices 102 can have an NFC reader/writer that enables it to read information stored on NFC tags 107 (e.g., in embedded cards or devices).

The wireless communication devices 102 can include computers (e.g., desktop, server, laptop), televisions (TVs) or components in communication with a TV (e.g., TV streamer), a car audio system or circuitry within the car, a mobile device (e.g., smartphone), tablet, remote control, an accessory electronic device, a wireless speaker, or watch. The wireless communication device 102 can also be a part of a fitting station, which is a computer that a hearing care professional can use to fit a hearing device.

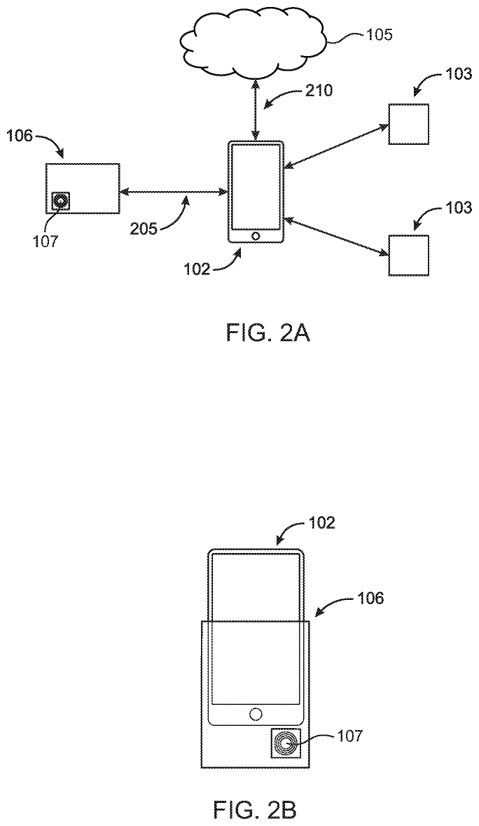

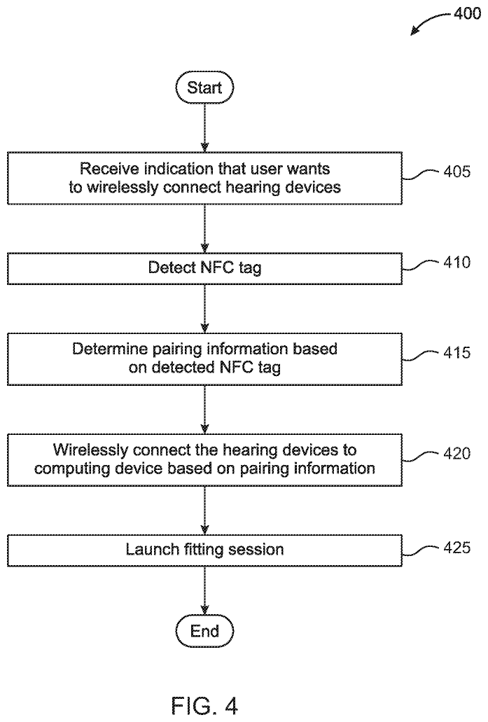

FIG. 1 also includes an NFC tag 107 associated with a card 106. A hearing device manufacturer can provide the card 106, e.g., a plastic card with an NFC chip built into the card 106. Alternatively, the card 106 can be a credit card or identification card associated with the user, wherein the card 106 has a built-in NFC tag. NFC tags are passive data stores that can be read by an NFC device (e.g., wireless communication device 102 with an NFC reader). NFC tags can contain read-only data, but may be rewritable (e.g., a wireless communication device 102 can write or change information in the NFC tag). Information on the NFC tag can be associated with secure personal data storage (e.g. debit or credit card information, pairing information, hearing device user information, hearing device information, personal identification numbers (PINs), contact information). In some implementations, the NFC tags 107 can be custom-encoded by their manufacturers or use the industry specifications. Further details regarding the card 106 and the NFC tag are disclosed in FIGS. 2A-2C and FIG. 4.

Also, FIG. 1 includes a hearing device holder 108 that can be a box configured to hold, carry, or protect hearing devices 103. The hearing device holder 108 can include a wireless charging circuit configured to wirelessly charge the hearing devices 103. The hearing device holder 108 can have a lid, a body, and a power input (e.g., plug) to receive electrical power from an electrical outlet. The hearing device holder 108 can be portable. The hearing device holder 108 can also have the NFC tag 107. The NFC tag 107 can be located inside or on the surface of the hearing device holder 108. A hearing device manufacturer can install the NFC tag 107 in the hearing device holder 108, e.g., when the hearing device holder 108 is manufactured. In some implementations, the card 106 can be inserted into the hearing device holder 108 such that the card 106 has the NFC tag and it is removable and portable. The NFC tag 107 can be active or passive, where passive does not require a power source and active requires access to a power source. Also, the NFC tag 107 can be associated with an International Organization for Standardization (ISO) standard (e.g., ISO14443A).

In some implementations, a wireless communication device 102 has an NFC reader and if a hearing device user holds the NFC reader near (e.g., within 1-10 cm) of the hearing device holder 108, the NFC reader of the wireless communication device 102 can determine information about the NFC tag such as user information.

The network 105 is a communication network. The network 105 enables the hearing devices 103 or the wireless communication devices 102 to communicate with a network or other devices. The hearing devices 103 and the wireless communication devices 102 can use the network to perform operations such as transmitting or receiving information from the third party database 112 or the customer database 110.

The network 105 can be a Wi-Fi™ network, a wired network, or a network implementing any of the Institute of Electrical and Electronic Engineers (IEEE) 802.11 standards. The network 105 can be a single network, multiple networks, or multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. In some implementations, the network 105 can include communication networks such as a Global System for Mobile (GSM) mobile communications network, a code/time division multiple access (CDMA/TDMA) mobile communications network, a 3rd, 4^{th}, or 5th generation (3G/4G/5G) mobile communications network (e.g., General Packet Radio Service (GPRS)) or other communications network such as a Wireless Local Area Network (WLAN).

The communication environment 100 includes a customer database 110 and a third party database 112 that can be accessed via the network 105. The customer database 110 can store information related to a hearing device user. For example, the customer database 110 can store user identification information such as name, phone number, address, medical history related to hearing (e.g., an audiogram or previous fitting session information). The customer database 110 can also store NFC tag information that can be used to look up user information associated with the NFC tag. The customer database 110 can also store hearing device information such as the make, model, and information necessary for pairing and wirelessly connecting the hearing device to another device.

The third party database 112 can store user information associated with a third party. For example, the third party database 112 can store credit or identity information for a user. The third party database 112 can also associate the NFC tag with a user. In some implementations, a third party may grant access to its NFC tag (e.g., credit card) such that a user or HCP can perform a look-up operation to wirelessly connect hearing devices.

FIG. 2A is a schematic illustration of the hearing devices 103 wirelessly connecting with a wireless communication device 102. The wireless communication device 102 can communicate with the network 105. A hearing device manufacturer can provide the card 106, e.g., a plastic card with an NFC chip built in. A user can carry the card 106 with him or her and use it at any time. Alternatively, the card 106 can be a credit card or identification associated with the user, wherein the card 106 has an NFC tag 107.

A hearing device user can cause the wireless communication device 102 to detect the NFC tag in numerous ways. As shown in FIG. 2B, the user can place the card 106 over or near the wireless communication device 102 and the wireless communication device 102 can use the NFC tag 107 to read out information. The wireless communication device 102 can use its NFC reader to detect and/or read the NFC tag 107. The wireless communication device 102 can then use the NFC tag 107 or information from reading the NFC tag to perform a look up operation to find information related to pairing the hearing devices 103 with the wireless communication device 102.

Also, as shown in FIG. 2C, a hearing device user can hold or place the wireless communication 102 on top, near, or around the hearing device holder 108 to read or write information from or to the NFC tag 107. The wireless communication device 102 can use its NFC reader to detect and/or read the NFC tag 107. The wireless communication device 102 can then use the NFC tag 107 to perform a look up operation to find information related to pairing the hearing devices 103 with the wireless communication device 102.

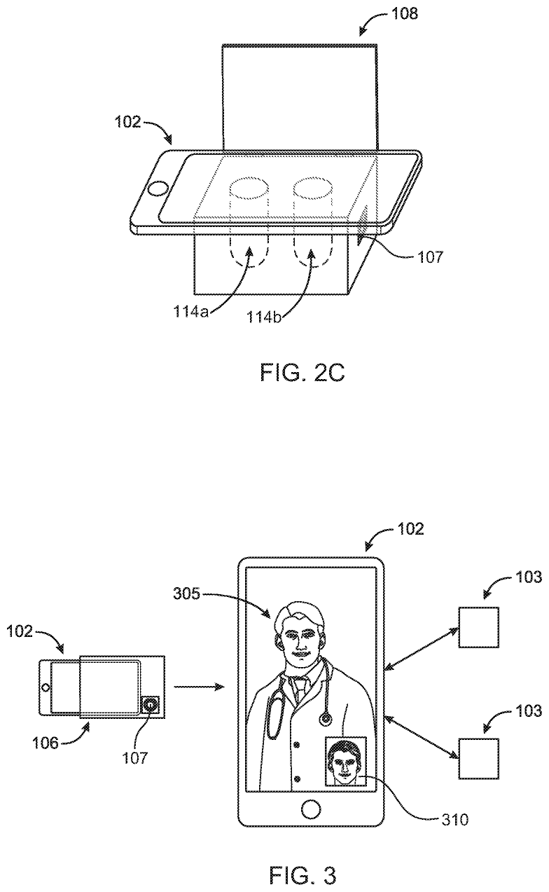

FIG. 3 is a schematic illustration of hearing devices 103, a wireless communication device 102, and a card 106 with an NFC tag 107 used to start a fitting session. The wireless communication device 102 has a screen that displays information related to the fitting session. A fitting session is an appointment with an HCP where the HCP determines or verifies that a hearing aid is providing a correct amount of amplification or hearing experience for a user. A fitting session can also include the HCP adjusting other parameters of the hearing devices (e.g., frequency settings) and can also include adjusting physical parameters (e.g., instructing the user to remove, extend, or add a component on the hearing aid). Specifically, the wireless communication device 102 can enable a video chat between a HCP and a hearing device user. The video chat can include reception and transmission of audio-video signals in real-time (or recorded). During a video chat, an HCP 305 can discuss all aspects of hearing with the hearing device user 310. As shown in FIG. 3, the hearing device user placed his or her card 106 near the wireless communication device 102, and the wireless communication device 102 launched or initiated a fitting session automatically after detecting the NFC tag. This can be accomplished based on the user engaging a mobile application that supports the fitting session and the launch process.

FIG. 4 is a block diagram for a process 400 for wirelessly connecting a hearing device with a wireless communication device. In some implementations, part of the process 400 may be carried out on more than one device. For example, on a server, on a computer at the HCP's office, on a wireless communication device, on the hearing device, or a combination of these devices. The process 400 begins with receive operation 405 and continues with detect NFC tag operation 410. The process 400 can also be referred to as an algorithm for wirelessly connecting a hearing device or launching a fitting session.

At receive indication operation 405, a wireless communication device or a hearing device receives that a user wants to wirelessly connect their hearing devices (or hearing device) to the wireless communication device. In some implementations, the user can open a mobile application that relates to wirelessly connecting hearing devices with their mobile phone. In the mobile application, the user can select to connect a hearing device (or hearing devices). Alternatively, the mobile application may be able to automatically detect a user's face and determine that the user is not wearing the hearing devices and thus wants to wirelessly connect them before putting them on (e.g., based on feature extraction and face recognition). In another implementation, the mobile application can detect that a user is wearing the hearing devices and determine that they are not connected to the phone.

At detect NFC tag operation 410, in response to the receive indication operation 405, the wireless communication device turns on (e.g., begins searching for) NFC fields or signals. For example, the NFC chip on a mobile phone can be activated to look for an NFC tag, and the mobile phone can use its NFC chip to read the NFC tag. The user can move their mobile phone close to a card with an NFC tag (e.g., a card from the hearing aid manufacturer or credit card). Based on the proximity, the mobile phone can read the NFC tag. Once the wireless communication device receives the information associated with the NFC tag, it can use that information to carry out other operations. For example, it can send a request to a server to get pairing information associated with the user's hearing devices. It can also send a request, via the internet, to determine which hearing devices are associated with a user and what information is necessary for pairing those hearing devices with the user. The disclosed technology can use the NFC tag information to begin a log on process, a sign in process for a fitting session, and for connecting with a hearing care professional (e.g., email address, video conference information, fitting session started information). In some implementations, the NFC tag may be associated with an encrypted or anonymized number or message that be used in a lookup table to find out pairing information or more information about the user or his or her hearing devices.

At pairing operation 415, the hearing devices (or hearing devices) and the wireless communication device pair. Pairing can include the wireless communication device looking for the hearing devices via Bluetooth™. Once the wireless communication device finds the hearing devices or devices, it can use the pairing information it received that is associated with the NFC tag operation 410 to send a pairing request to the hearing devices. In some implementations, pairing may include the transfer or confirmation of a passkey or password, which can be obtained from the NFC tag.

At wireless connection operation 420, after the pairing operation 415, the wireless communication device and the hearing devices (or device) can wirelessly connect. This generally means the two devices have a connection and can exchange data (e.g., to stream audio). The wireless connection can be secure because the wireless communication device and the hearing device underwent the pairing operation 415.

At fitting session operation 425, the wireless communication device can launch a fitting session. Because the user opened a mobile application in receive indication operation 405, the wireless communication device has a user interface where it can launch a video screen. The mobile application can transmit data from the wireless communication device to a hearing care professional on the other end. Based on the NFC tag, the wireless communication device can launch the fitting session without additional login information or user information. Rather, the NFC tag can be associated with all necessary information for a user to launch a fitting session or the mobile device can use the NFC tag to send calls to servers to get necessary user information to perform the launch a fitting session. For example, the NFC tag can be associated with a ID, and the wireless communication device can use this ID to perform a back-end lookup operation for an HCP's contact information and use this information to launch the fitting session automatically for the user. During the fitting session operation 425, the hearing device user and a HCP can communicate regarding the hearing device. The HCP can also control or access the hearing devices for the user to perform hearing device adjustments (e.g., change settings for the hearing devices).

Aspects and implementations of the process 400 have been disclosed in the general context of various steps and operations. A variety of these steps and operations may be performed by hardware components or may be embodied in computer-executable instructions, which may be used to cause a general-purpose or special-purpose processor (e.g., in a computer, server, or other computing device) programmed with the instructions to perform the steps or operations. The steps or operations may be performed by a combination of hardware, software, and/or firmware such with a wireless communication device or a hearing device. For example, if devices have previously paired, the pairing operation 425 can be skipped or altered based on saved pairing information stored in the wireless communication device. The process 400 can be stored in a non-transitory computer readable medium, wherein the non-transitory computer readable medium can store instructions or operations to carry out process 400 or parts of process 400.

The phrases “in some implementations,” “according to some implementations,” “in the implementations shown,” “in other implementations,” and generally mean a feature, structure, or characteristic following the phrase is included in at least one implementation of the disclosure, and may be included in more than one implementation. In addition, such phrases do not necessarily refer to the same implementations or different implementations.

The techniques introduced here can be embodied as special-purpose hardware (e.g., circuitry), as programmable circuitry appropriately programmed with software or firmware, or as a combination of special-purpose and programmable circuitry. Hence, implementations may include a machine-readable medium having stored thereon instructions which may be used to program a computer (or other electronic devices) to perform a process. The machine-readable medium may include, but is not limited to, optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. In some implementations, the machine-readable medium is non-transitory computer readable medium, where in non-transitory excludes a propagating signal.

The above detailed description of examples of the disclosure is not intended to be exhaustive or to limit the disclosure to the precise form disclosed above. While specific examples for the disclosure are described above for illustrative purposes, various equivalent modifications are possible within the scope of the disclosure, as those skilled in the relevant art will recognize. For example, while processes or blocks are presented in an order, alternative implementations may perform routines having steps, or employ systems having blocks, in a different order, and some processes or blocks may be deleted, moved, added, subdivided, combined, or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. As another example, “A or B” can be only A, only B, or A and B.

1. A computer-implemented method for wirelessly connecting a hearing device and a wireless communication device, the method comprising:
receiving an indication that a hearing device user wishes to wirelessly connect a hearing device to a wireless communication device;
detecting a near-field communication (NFC) tag that is associated with the hearing device or the hearing device user;
in response to detecting the NFC tag, determining pairing information for the hearing device; and
wirelessly connecting the hearing device to the wireless communication device after pairing the hearing device and the wireless communication device.

2. The computer-implemented method of claim 1, wherein receiving the indication further comprises:
receiving a request from a mobile application in the wireless communication device, wherein the request is associated with a user toggling a button on a user interface for the mobile application or an automatic request based on the hearing device user opening the mobile application.

3. The computer-implemented method of claim 1, wherein the method further comprises:
sending, via the wireless communication device, the NFC tag to a wireless network to request pairing information or user information associated with the hearing devices; and
receiving, via the wireless network, a response to the pairing request including hearing device pairing formation.

4. The computer-implemented method of claim 1, the method further comprising:
initiating a fitting session after wirelessly connecting the hearing device and the wireless communication device.

5. The computer-implemented method of claim 1, wherein the hearing device is a first hearing device, and the method further comprises:
based on the detected NFC tag, determining pairing information for a second hearing device; and
wirelessly connecting the second hearing device to the wireless communication device after pairing the second hearing device and the wireless communication device.

6. The computer-implemented method of claim 1, wherein the NFC tag is associated with a card for the hearing device user.

7. The computer-implemented method of claim 1, wherein the NFC tag is associated with a hearing device configured to store and charge the hearing device.

8. The computer-implemented method of claim 1, wherein determining pairing information for the hearing device further comprises:
performing a lookup or search operation based on the NFC tag to find pairing information, wherein the lookup or search operation is performed on a third party database or customer database.

9. The computer-implemented method of claim 1, wherein the NFC tag is encrypted.

10. The computer-implemented method of claim 1, the method further comprising:
using the NFC tag to look up hearing care professional contact information; and
launching a fitting session based on the looked up hearing care professional contact information.

11. A computer program product including instructions that when executed by a processor or processors, cause a device or devices to perform operations, the operations comprising:
receive an indication that a hearing device user wishes to wirelessly connect a hearing device to a wireless communication device;
detect a near-field communication (NFC) tag that is associated with the hearing device or the hearing device user; and
based on the detected NFC tag, determine pairing information for the hearing device; and
wirelessly connect the hearing device to the wireless communication device after pairing the hearing device and the wireless communication device.

12. The computer program product of claim 11, wherein the operations further comprise:
receive a request from a mobile application in the wireless communication device, wherein the request is associated with a user toggling a button on a user interface for the mobile application or an automatic request based on the hearing device user opening the mobile application.

13. The computer program product of claim 11, wherein the operations further comprise:
send, via the wireless communication device, the NFC tag to a wireless network to request pairing information or user information associated with the hearing devices; and
receive, via the wireless network, a response to the pairing request including hearing device pairing formation.

14. The computer program product of claim 11, wherein the operations further comprise:
start a fitting session after wirelessly connecting the hearing device and the wireless communication device.

15. The computer program product of claim 11, wherein the operations further comprise:
based on the detected NFC tag, determine pairing information for a second hearing device; and
wirelessly connecting the second hearing device to the wireless communication device after pairing the second hearing device and the wireless communication device.

16. The computer program product of claim 11, wherein the NFC tag is associated with a card for the hearing device user.

17. A system for providing a filter to a hearing device, the system comprising:
a first hearing device;
a second hearing device;
a near-field communication (NFC) tag associated with hearing device user information; and
a hearing device holder configured to wirelessly charge the first and second hearing device, wherein the hearing device holder is physically coupled to the NFC tag.

18. The system of claim 17, wherein the first hearing and the second hearing are receiver-in-the-canal devices, and wherein the first and second hearing devices include a lithium-ion battery, and the first and second hearing devices are configured for wirelessly charging of the battery.

19. The system of claim 17, the system further comprising: wherein the NFC tag coupled to a card and the card is removably attached the hearing device holder.
